(19) United States
(12) Patent Application Publication
(10) Pub. No.: US 2008/0120204 A1
(43) Pub. Date: May 22, 2008

(54) Method for transferring product service records

(75) Inventors: William Gary Conner, Peoria, IL (US); Arne Gerhard Christian Brand, Hamburg (DE); Mark Alan Sauvageau, Minonk, IL (US); Simone Jean Woods, Houston, TX (US); Gregory James Burdick, Cypress, TX (US); Mark Glenn Hexum, Hamburg (DE)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/589,960

(22) Filed: Oct. 31, 2006

(51) Int. Cl. G06Q 10/00

(52) U.S. Cl. 705/28

(57) ABSTRACT

A computer system is disclosed for tracking and transferring product service records using a product service history database. The computer system includes a computer readable medium having instructions for receiving service information associated with a product. The medium also has instructions for receiving service dealers' demographic information and receiving an indication of a transfer of the product from a first location to a second location. The medium further has instructions for determining a service dealer associated with the second location and providing the service information to the service dealer.

### TECHNICAL FIELD

The present disclosure is directed to the field of product service management and, more particularly, to a method for transferring product service records as a product moves from one service region to another.

### BACKGROUND

Products that require regular preventative service and periodic repairs often must be maintained at an approved service location. These service locations or service dealers must have adequate inventory and equipment to facilitate these services. The inventory and equipment must be sufficient to serve the day-to-day needs of customers such that products can be serviced in a timely fashion. Customers expect that when a product they have purchased requires service, a service dealer will be equipped and available to facilitate such service.

Typically, each service dealer keeps records of the customers that they personally serve and the work that has been done on their customers' products. The service dealers also have methods for obtaining warranty information and replacement parts for products that come under their care. However, the service dealers do not necessarily have advance notice of what products they will be asked to service and may have to delay service while waiting for particular parts to arrive, or even decline a request for service because they are not sufficiently equipped to provide the requested service.

Furthermore, customers expect service to be available regardless of their geographic location, and moving from one location to another location should not negate their ability to obtain efficient service on the product that they own. When a customer decides to move a product from one location to another location, they may leave the service area of their current service dealer and be required to find a new dealer sufficiently equipped to handle their product. Without advance notice of a new product entering its service area, a predictable schedule of when that product may require maintenance or repairs, or knowledge of what equipment may be required for the service, a service dealer may be unable to service the product in a timely manner. Since the customer leaves their product's service history behind with their last service dealer, the new service dealer must also treat the product without any knowledge of prior work completed on it.

One method that has been developed to manage service history for vehicles is described in U.S. Pat. No. 6,308,120 issued to U-Haul International, Inc. on Oct. 23, 2001 (the '120 patent). The '120 patent describes a method for disseminating service history for a vehicle or fleet of vehicles via an electronic network among a set or sets of nodes in a plurality of distinct geographical areas so that informed decisions can be made about the vehicle's availability and capability. Each node in this network can see which vehicles are currently being serviced, which vehicles have diminished capabilities due to service, or which vehicles will soon require service. Also, the system can allow for individual service locations to be alerted to vehicles in their care that have not completed service within an expected time frame.

The system of the '120 patent is driven by “service events,” which are recorded by service locations when a vehicle requires or is undergoing service. These service events are periodically sent from the individual dealer registering the event through the network to a single central management system, which periodically updates the entire network. Based on this information, the individual locations can make informed decisions about how to schedule vehicles for use by a customer. Multiple messages, therefore, are sent up the network tree and then down the network tree to indicate a need for service, commencement of service, completion of service, or a warning regarding the amount of time spent on service. In this approach, it is necessary for the vehicle associated with a recorded service event to be at the same geographic location as one of the nodes, but it is not necessary to alert the network of the location of the vehicle. Also, the information is not generally coupled such that a service event uploaded to the network is necessarily disseminated back down through the network.

Although the system of the '120 patent may successfully track the service history of a vehicle or fleet of vehicles, it does not allow for an efficient transfer of data. In particular, the system of the '120 patent requires voluntary notification of each successive service event from each participating service dealer, which increases the risk of erroneous or inconsistent data entry. Since the data flow is not automatic or necessarily coupled in the up and down directions of the network tree, all data that the method aims to transmit may be improperly disseminated as a vehicle is moved from one location to another. In addition, since the location of a vehicle in the service history database is not communicated to the network, a particular service station is not given any chance to prepare itself to service a vehicle that is entering its service area.

The present disclosure is directed to overcoming one or more of the problems set forth above.

### SUMMARY OF THE INVENTION

In accordance with one aspect, the present disclosure is directed toward an exemplary computer readable medium, tangibly embodied, including a product service history database. The computer readable medium includes instructions for receiving service information associated with a product. The medium also includes instructions for receiving service dealers' demographic information and receiving an indication of a transfer of the product from a first location to a second location. The medium further includes instructions for determining a service dealer associated with the second location and providing the service information to the service dealer.

According to another aspect, the present disclosure is directed toward an exemplary method for providing a product service history database. The method includes receiving service information associated with a product. The method also includes receiving service dealers' demographic information and receiving an indication of a transfer of the product from a first location to a second location. The method further includes determining a service dealer associated with the second location and providing the service information to the service dealer.

According to another aspect, the present disclosure is directed to an exemplary computer system including a platform, at least one input device, and a central processing unit in communication with the platform and the at least one input device. The central processing unit may be configured to receive service information associated with a product. The central processing unit may also be configured to receive service dealers' demographic information and to receive an indication of a transfer of the product from a first location to a second location.. Furthermore, the central processing unit may be configured to determine a service dealer associated with the second location and provide the service information to the service dealer.

### BRIEF DESCRIPTION OF THE DRAWINGS

FIG. 1 is a diagrammatic illustration of an exemplary disclosed product service tracking network;

FIG. 2 is a diagrammatic illustration of an exemplary disclosed product service tracking system;

FIG. 3 is a flowchart illustration of an exemplary disclosed method of tracking product service histories; and

FIG. 4 is a diagrammatic illustration of an exemplary disclosed product service tracking scenario.

### DETAILED DESCRIPTION

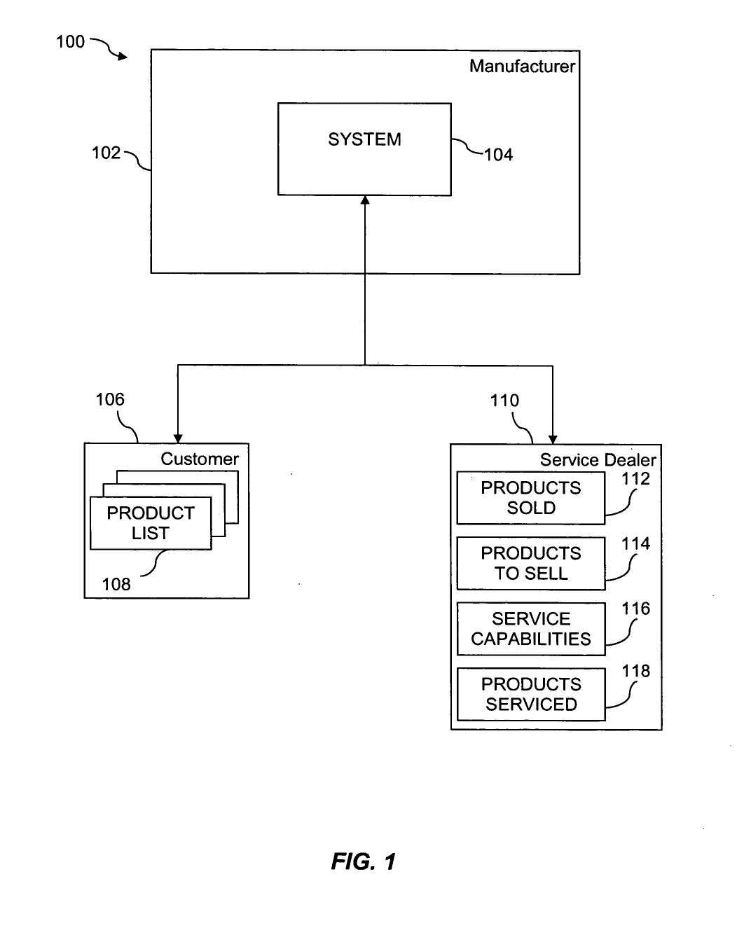

FIG. 1 illustrates an exemplary disclosed product service tracking network 100. Product service tracking network 100 may include any type of environment associated with monitoring and managing product service records for a population of products. For example, product service tracking network 100 may include a product manufacturer's headquarters with a system configured to oversee the operations of the manufacturing business, including finances, public and customer relations, human resources, parts inventories, and manufacturing and shipping schedules. As used herein, the term “part” may refer to a portion into which a product is divided. For example, a “product” may be a vehicle including a plurality of “parts,” such as an engine, fuel system, tires, a transmission, or any other suitable component of the vehicle.

Product service tracking network 100 may include a manufacturer 102, an end-user customer (the “customer”) 106, and a service dealer 110. Manufacturer 102 may include, among other things, a system 104. Customer 106 and service dealer 110 may each be connected to system 104 through appropriate securities (not shown) or an application server with appropriate securities (not shown). Appropriate securities may include a firewall or a password-protected access terminal. Although illustrated as a single customer 106, a single service dealer 110, and a single system 104, a plurality of customers 106 or service dealers 110 may be connected to either a single, centralized system 104 or a plurality of distributed systems 104.

Customer 106 may include a listing of the products 108 currently in the customer's keeping. For example, customer 106 may keep an inventory of each product for which it is responsible, either by direct ownership or through a lending or leasing agreement with other product owners. Customer 106 may index its products by grouping them with a unique identifier for a larger system containing the product as components therein, and assigning a single product application identifier to the larger system. For example, a C280-6 engine may be included in a customer's oil rig, identified by the customer 106 as rig number 12345678. Thus, the product application identifier for the C280-6 engine may also be 12345678.

Service dealer 110 (the “dealer”) may include records of products sold 112, and products in inventory to sell 114. Records of products sold 112 may include a listing of the end-user customer of each product, as well as the manufacturer and type of product. Service dealer 110 may further include records of its service capabilities 116 and products currently serviced 118. Records of service capabilities 116 may include, for example, the equipment and parts available to service dealer 110 for use in servicing products, as well as a catalog from which service dealer 110 may supplement its inventory. Records of service capabilities 116 may further include a list of products that service dealer 110 is equipped to service. Records of products serviced 118 may include the contact information for and the location of the customer owner 106 of each product serviced, and the date and type of service performed.

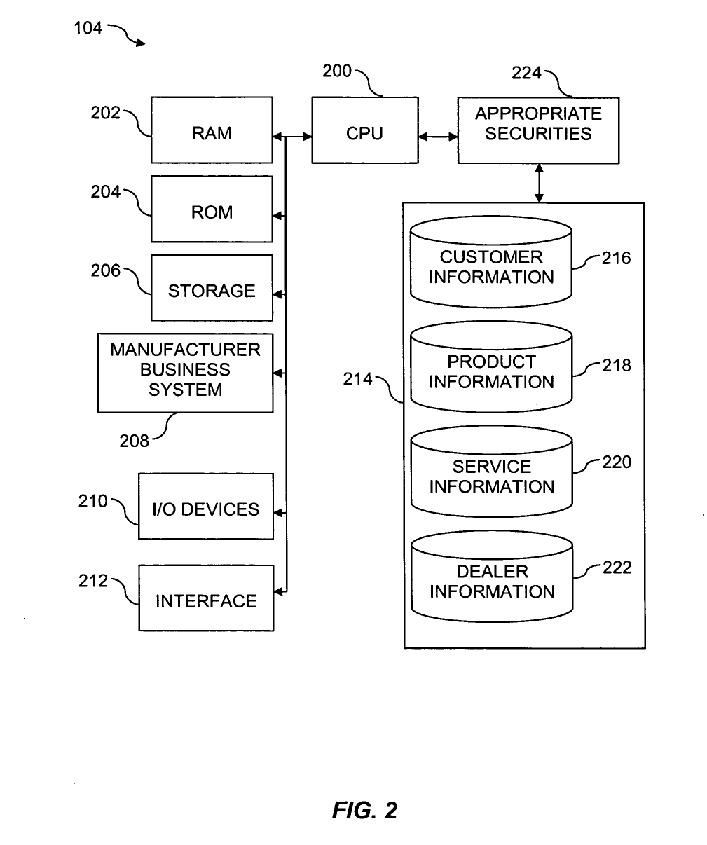

FIG. 2. depicts an exemplary disclosed product service tracking system 104. System 104 may include any type of processor-based system on which processes and methods consistent with the disclosed embodiments may be implemented. For example, system 104 may include one or more hardware and/or software components configured to execute software programs, such as a manufacturer business system 208.

Hardware components of system 104 may include a central processing unit (CPU) 200, a random access memory (RAM) module 202, a read-only memory (ROM) module 204, a storage 206, a manufacturer business system 208, one or more input/output (I/O) devices 210, an interface 212, and any number of databases 214. Examples of such databases 214 include customer information 216, product information 218, service information 220, and dealer information 222 databases. Databases 214 may be connected, jointly or separately, to the remainder of system 104 through appropriate securities 224. Examples of appropriate securities 224 include role-based access restrictions and a firewall.

Software components of system 104 may include a computer-readable medium including computer-executable instructions for performing methods consistent with certain disclosed embodiments. One or more of the hardware components listed above may also be implemented using software. For example, storage 206 may include a software partition associated with one or more other hardware components of system 104, such as databases 214. System 104 may include additional, fewer, and/or different components than those listed above, as the components listed above are exemplary only and not intended to be limiting.

CPU 200 may include one or more processors, each configured to execute instructions and process data to perform one or more functions associated with system 104. As illustrated in FIG. 2, CPU 200 may be communicatively coupled to RAM 202, ROM 204, storage 206, manufacturer business system 208, I/O devices 210, interface 212, and databases 214. CPU 200 may be configured to execute sequences of computer program instructions to perform various processes, which will be described in detail below. The computer program instructions may be loaded into RAM 202 for execution by CPU 200.

RAM 202 and ROM 204 may each include one or more devices for storing information associated with an operation of system 104 and CPU 200. RAM 202 may include a memory device for storing data associated with one or more operations of CPU 200. For example, ROM 204 may load instructions into RAM 202 for execution by CPU 200. ROM 204 may include a memory device configured to access and store information associated with system 104, including information for identifying, initializing, and monitoring the operation of one or more components and subsystems of system 104.

Storage 206 may include any type of mass storage device configured to store information that CPU 200 may need to perform processes consistent with the disclosed embodiments. For example, storage 206 may include one or more magnetic and/or optical disk devices, such as hard drives, CD-ROMs, DVD-ROMs, or any other type of mass media device.

Manufacturer business system 208 may include a software product that allows manufacturer to manage business operations, including finances, public and customer relations, human resources, parts inventories, manufacturing and shipping schedules, and service history management. Service history management may involve communication with customer 106, dealer 110, manufacturer 102, and databases 214. Manufacturer business system may provide or receive these communications via I/O devices 210 or interface 212.

Manufacturer business system 208 may receive information from customer 106, including: customer demographic information, such as a customer's name, location, contact information, and product list 108; indications of a product's movement from a first location to a second location; the date of arrival of a product at a location; and product application information, such as vehicle identifier or rig number. Manufacturer business system 208 may include the capability of requesting information from customer 106 or receiving information without any prior expectation of receipt if, for example, customer 106 volunteers information to manufacturer business system 208. Manufacturer business system 208 may further communicate information to customer 106, such as the locations of service dealers near customer 106 with the capability of servicing one or more of the customer's products. Information communicated to customer 106 by manufacturer business system 208 may be provided in response to a request by customer 106, automatically by manufacturer business system 208, or in response by some other event such as the expiration of a warranty period.

Manufacturer business system 208 may also receive information from dealer 110, including: dealer demographic information, such as a dealer's name, location, contact information, service capabilities 116, parts in inventory (not shown), and products serviced by the dealer 118; and service updates. Manufacturer business system 208 may include the capability of requesting information from dealer 110 or receiving information without any prior expectation of receipt if, for example, dealer 110 volunteers information to manufacturer business system 208. Manufacturer business system 208 may further communicate information to dealer 110, such as the expected arrival date of a product in dealer's 110 service area and a service history report for that product. The service history report may include service information such as, for example, past service performed on the product, parts included in the product, warranty information for the product, machine hours recorded by the product, the service locations where past service was performed on the product, service instructions for the product, safety information for the product, customer's 106 application of the product, the product's serial number, and the geographical location of the product. Information communicated to dealer 110 by manufacturer business system 208 may be provided in response to a request by dealer 110, automatically by manufacturer business system 208, or in response by some other event such as an indication that a product will be entering a dealer's 110 service area. In an alternative example, manufacturer business system 208 may also communicate with an automated product tracking system, such as Global Positioning Satellites (GPS), which may serve as an alternate indication that a product has entered a dealer's 110 service area, thus triggering the manufacturer business system 208 to communicate the product's service history report to the dealer 110.

Information may also be communicated to and from manufacturer business system 208 by manufacturer 102 and/or databases 214. Manufacturer 102 may add, view, or modify parts lists, product service information, warranty information, or system user information through manufacturer business system 208.

Some or all of the data described above may be communicated by manufacturer business system 208 to databases 214. Manufacturer business system 208 may also be configured to query databases 214 for data in order to display or output the data, or in order to generate and deliver service history reports. For example, manufacturer business system 208 may generate a service history report by querying databases 214 in order to obtain information on a specific product, such as information about the end-user customer of that product, and the product's service history, parts list, service instructions, and warranty information.

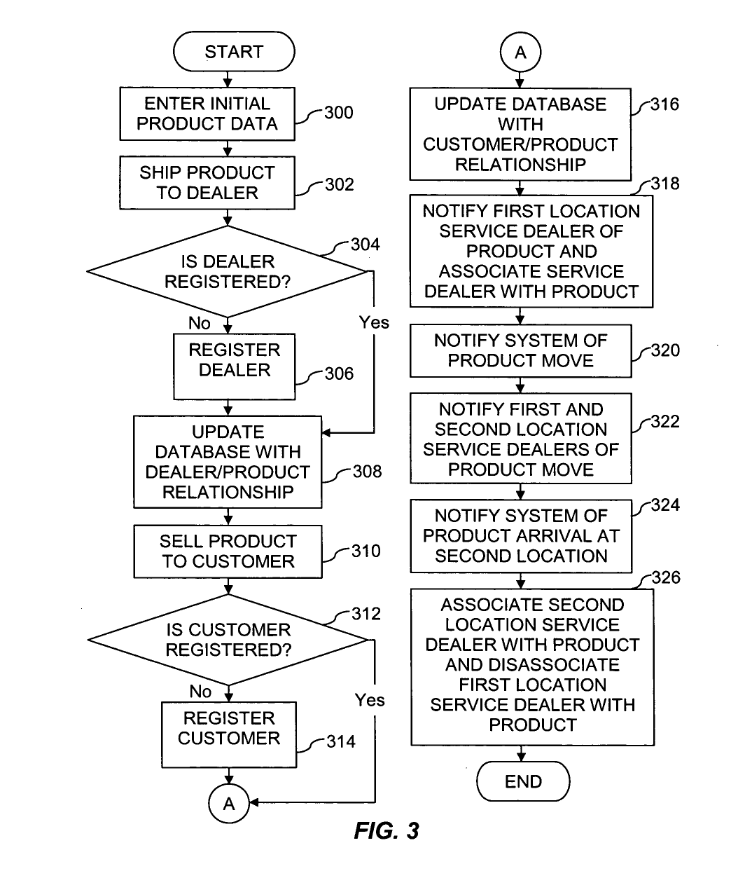

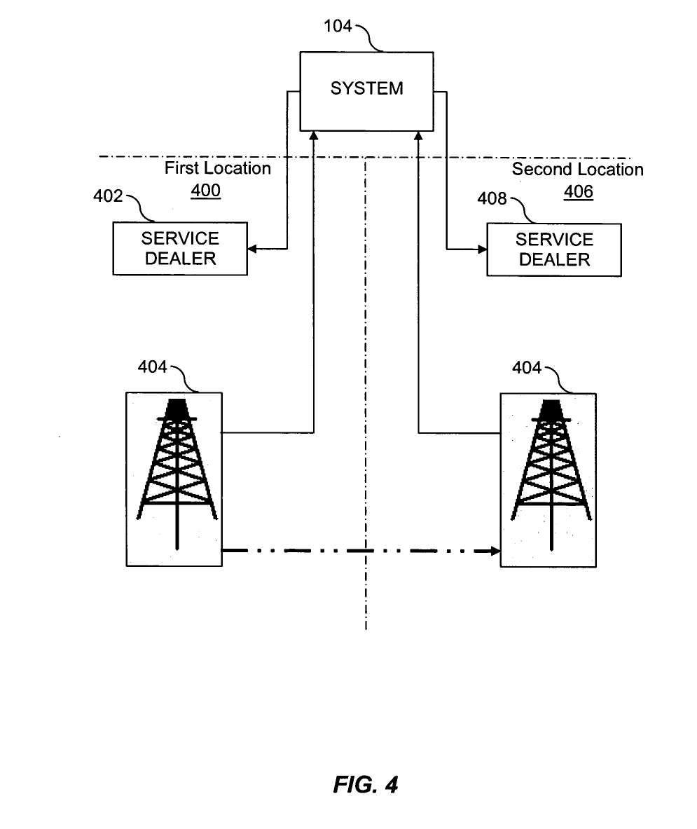

Similarly, manufacturer business system 208 may run computations in conjunction with data obtained from any source. For example, manufacturer business system 208 may receive an indication from customer 106 that a particular product is moving from a first location to a second location. Manufacturer business system 208 may then query databases 214 for a list of equipment and parts required to service that product, followed by a list of dealers with the equipment necessary to service that particular product. Manufacturer business system 208 may then use an algorithm to compute the closest service dealer 110 to the second location and use customer contact information received from databases 214 to transmit this data to customer 106. The process of tracking service history with regard to customers 106 and dealers 110 will be described in more detail below with reference to FIGS. 3 and 4.

Manufacturer business system 208 may allow different users different levels of access to various portions of the service history tracking tool depending on the type of user. Types of user may include, without limitation, administrative manufacturer users, customer users, and dealer users. For example, administrative manufacturer users may view the product history for any product, register new customer users in system 104, register new dealer users in system 104, and modify parts, service, or warranty information for any product. However, service dealer users may only be able to edit their own demographic information, view products in their particular service area, view parts, service, or warranty information for those products, and view demographic information for customers 106 keeping those products. Similarly, customer users may only be able to edit their own demographic information, view or modify the list of products in their keep, view parts, service, or warranty information for those products, view demographic information for service dealers 110 registered to service those products, and view a map with directions from the customer's location to those service dealers.

Although illustrated as a single manufacturer business system 208, the functionality provided by manufacturer business system 208 may be separated into two or more software products. For example, manufacturer 102 may use an existing manufacturer business system 208 and install a service history tracking tool on system 104. The service history tracking tool may, for example, serve as a link between manufacturer business system 208 and interface 212. In this example, the service history tracking tool may download the above-described information from databases 214. Manufacturer business system 208 may then import this information from the service history tracking tool and use the information in accordance with the present disclosure.

Alternatively, the portions of manufacturer business system 208 that provide a service history tracking tool may be integrated with an existing system used by manufacturer 102. Manufacturer business system 208 may also be separate from system 104 and communicate with system 104 via interface 212.

I/O devices 210 may include one or more components configured to communicate information with a user associated with system 104. For example, I/O devices 210 may include a console with an integrated keyboard and mouse to allow a user to input parameters associated with system 104. I/O devices 210 may also include a display, such as a monitor, including a graphical user interface (GUI) for outputting information. I/O devices 210 may also include peripheral devices such as, for example, a printer for printing information associated with system 104, a user-accessible disk drive (e.g., a USB port, a floppy, CD-ROM, or DVD-ROM drive, etc.) to allow a user to input data stored on a portable media device, a microphone, a speaker system, or any other suitable type of interface device. Although not illustrated, databases 214 may also include I/O devices 210 that allow user interaction.

The results of received data may be provided as output from system 104 to I/O device 210 for printed display, viewing, and/or further communication to other system devices. Such output may include, for example, current products reported in transit, reported service or warranty information, service history reports, and the location of a service dealer assigned to a particular customer's product. Output from system 104 can also be provided to databases 214 to track service history, recommend a suitable service dealer 110 for a customer 106 who is moving to a new location, and provide service history for a particular customer's 106 product to the service dealer 110 responsible for the customer's 106 product in the new location.

Interface 212 may include one or more components configured to transmit and receive data via a communication network, such as the Internet, a local area network, a workstation peer-to-peer network, a direct link network, a wireless network, or any other suitable communication platform. In this manner, manufacturer 102, customer 106, and dealer 110 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 212 may include one or more modulators, demodulators, multiplexers, demultiplexers, network communication devices, wireless devices, antennas, modems, and any other type of device configured to enable data communication via a communication network. Interface 212 may also include components necessary to create an application server, through which customer 106 and dealer 110 may transmit and receive data to and from system 104. For example, customer 106 and dealer 110 may log in to system 104 through a website using unique usemames and passwords, the website allowing users to view, add, modify, or delete information communicated through system 104 and appropriate to the each user's assigned access privileges.

Databases 214 may include one or more software and/or hardware components that cooperate to store, organize, sort, filter, and/or arrange data used by system 104 and CPU 200. For example, databases 214 may include: customer information, such as a customer's name, location, contact information, and products currently under the customer's keeping; product information, such as a product's parts, service instructions for the product, equipment required to service the product, product application identifier, and the product's warranty information; service information, such as a record of each service action taken on a product, comprising the product's service history; and dealer information, such as a dealer's name, location, contact information, and products the dealer is equipped to service or servicing equipment available to the dealer. CPU 200 may access the information stored in databases 214 for comparing a product owned by a customer with the product servicing capabilities of service dealers in the customer's locality to determine which dealer with the ability to service that product is closest to the customer. CPU 200 may also compile service history data for a particular service dealer for products in or newly entering the service dealer's servicing area, while utilizing appropriate securities to guard this data from other dealers' or customers' view. Collectively, the information in databases 214 may be used by system 104 or components of the same, such as manufacturer business system 208 or CPU 200, to manage product service histories, as exemplified above.

Those skilled in the art will appreciate that all or part of the systems and methods consistent with the present disclosure may be stored on or read from other computer-readable media. Product service tracking system may include a computer-readable medium having stored thereon machine executable instructions for performing, among other things, the methods disclosed herein. Exemplary computer readable media may include secondary storage devices, such as hard disks, floppy disks, and CD-ROM; a carrier wave received from the Internet; or other forms of computer-readable memory, such as random-access memory (RAM) 202 or read-only memory (ROM) 204. Such computer-readable media may be embodied by one or more components of system 104, such as CPU 200, storage 206, manufacturer business system 208, interface 212, databases 214, or combinations of these and other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these program modules may be implemented using commercially available software tools, using custom object-oriented code written in the C++ programming language, using applets written in the Java programming language, or may be implemented with discrete electrical components or as one or more hardwired application specific integrated circuits (ASIC) custom designed for this purpose.

The described implementation may include a particular network configuration but embodiments of the present disclosure may be implemented in a variety of data communication network environments using software, hardware, or a combination of hardware and software to provide the processing functions. Exemplary processes and methods consistent with the invention will now be described with reference to FIGS. 3 and 4.

### INDUSTRIAL APPLICABILITY

The disclosed method and system may provide product service history tracking for manufacturers, customers, and dealers. In particular, the disclosed method and system may be used to implement a tracking tool that facilitates seamless transfer of service history for a product from a service dealer in a first location to a service dealer in a second location. Thus, as a customer moves a product from the first location to the second location, an appropriate service dealer in the second location can be notified of the product entering its service area and of the product's recorded service information, allowing it to prepare its equipment, schedule, inventory of parts, and take any other actions in preparation for foreseeable maintenance and repairs. In this manner, the service dealer may monitor and maintain adequate inventory levels to service the needs of customers, and customers can easily locate a service dealer prepared for their business in new locations.

FIG. 3 depicts an exemplary process consistent with the present disclosure. As illustrated in FIG. 3, the first step in the functioning of the service history tracking tool may include initially entering product data when a product has been manufactured (Step 300). Initial product data may be entered into service information database 220 via I/O devices 210 and/or interface 212. Initial product data may include a unique product identifier and the type of product. The unique product identifier may be a serial number or other serializable word that can be used to uniquely identify the product within system 104. The type of product may be a model number. For example, one product may be a C280-6 petroleum engine with serial number 87654321. The unique product identifier of this engine may be 87654321, and its product type may be C280-6.

This initial data entry may be completed manually by manufacturer 102 or automatically by another component of system 104 or an external system (not shown) communicatively coupled with system 104. For example, a product inventory system may be updated each time a product's manufacture has completed, such update triggering the product inventory system to update product information database with the above initial product data.

Once the product has been manufactured, the product may be delivered to dealer 110 (Step 302), per a product order. System 104 may then associate the product with dealer 110. For example, manufacturer 102 may check whether or not dealer 110 is registered with system 104 by querying dealer information database 222. If dealer 110 is not registered, manufacturer 102 may register dealer 110 with system 104 by adding dealer's 110 demographic information to dealer information database 222, as collected by dealer's 110 order for the product. This information may be entered into dealer information database 222 via I/O devices 210 and/or interface 212. Similarly, the dealer registration may be automatically completed by another component of system 104 or an external system (not shown) communicatively coupled with system 104. For example, a product shipping system may monitor product orders and, as part of its routine for processing product orders, may check for dealer registration (Step 304) and register those dealers (Step 306) not already in dealer information database. Once registered, unique login information may be communicated to dealer 110. Service dealer 110 may further be asked to transmit information indicating products dealer 110 is equipped to service or servicing equipment available to the dealer 116, as well as a listing of products that have been serviced by dealer 110 and the date and type of service 118. This data may be added to dealer information database 222 and service information database 220, respectively, and may be entered via forms on a web-site, as a part of interface 212. In an alternative embodiment, dealers 110 may voluntarily register with system 104 to supply any or all of the above information through forms on a web-site, as part of interface 212.

Once dealer 110 has a verified registration with system 104, the product may be recorded in service information database 220 as being in the possession of dealer 110 (Step 308). Step 308 may be completed automatically by system 104 or by an external system (not shown) communicatively coupled with system 104, or manually by manufacturer 102 via I/O devices 210 and/or interface 212.

The status of the product may remain unchanged in databases 214 until customer 106 purchases the product from dealer 110 (Step 310). Upon this change of ownership of the product, the product may be associated with customer 106. For example, manufacturer 102 may check whether or not customer 106 is registered with system 104 by querying customer information database 216. If customer 106 is not registered, manufacturer 102 may register customer 106 with system 104 by adding customer's 106 demographic information to customer information database 216, as reported by dealer's 110 record of sale for the product. This information may be entered manually into customer information database 216 via I/O devices 210 and/or interface 212. Similarly, the customer registration may be automatically completed by another component of system 104 or an external system (not shown) communicatively coupled with system 104. For example, a product warranty system may monitor product sales and, as part of its routine for accepting product sale information, may check for customer registration (Step 312) and register those customers 106 (Step 314) not already in customer information database 216. Once registered, unique login information may be communicated to customer 106. Customer 106 may further be asked to transmit information indicating products currently under the customer's keep. This data may be added to customer information database 216, and may be entered via forms on a web-site, as a part of interface 212. An alternative embodiment may require customers 106 to voluntarily register with system 104 supplying all of the above information through forms on a web-site, as part of interface 212.

Once customer 106 has a verified registration with system 104, the product may be recorded in customer information database 216 and/or service information database 220 as being in the possession of customer 106 (Step 316). This step may further include associating the product with a product application identifier indicated by customer 106 via I/O devices 210 and/or interface 212, automatically by another component of system 104, or by an external system (not shown) communicatively coupled with system 104. A product application identifier may be a unique identifier for a larger system containing the product as components therein. The type of product may be relationally correlated with that type of product's parts, service information, and warranty information in product information database 218. For example, an oil rig with serial number 12345678 may contain a C280-6 petroleum engine with serial number 87654321. In consideration of the C280-6 product, its unique product identifier may be 87654321, its product application identifier may be 12345678, and its product type may be C280-6. Step 316 may be completed automatically by system 104 or by an external system (not shown) communicatively coupled with system 104, or manually by manufacturer 102 via I/O devices 210 and/or interface 212.

The remainder of the process illustrated in FIG. 3 is also exemplified in FIG. 4. With the product in customer's 106 possession, system 104 may notify a service dealer 402 responsible for servicing products in customer's 106 current geographic location 400 that a product 404 is in service dealer's 402 area of service (Step 318). Service dealer 402 may be located by querying dealer information database 222 for a list of service dealers with the capability to service product 404, choosing service dealer 402 from that list as the service dealer nearest to the product's location 400. This association with and notification of service dealer 402 may be completed manually by manufacturer 102 or automatically by another component of system 104. Furthermore, if customer 106 was newly registered with system 104 in step 314, step 316 may be repeated for each product in the customer's keep.

Although not illustrated, embodiments of the present disclosure may require that system 104 receive notification of services conducted by each registered service dealer 110 on each product serviced, including maintenance and repair work. In a preferred embodiment, service dealer 110 may notify system 104 of the product serviced, type of service rendered, date of service, and any other information relevant to the maintenance of a complete service history, such as applicable warranty information. This transfer of data may be completed manually by service dealer 110 via I/O devices 210 and/or interface 212 or automatically by a system used by dealer 110, such as a service event recording system communicatively coupled with system 104 via I/O devices 210 and/or interface 212.

The customer 106/product 404/service dealer 402 relationship may be maintained in databases 214 until system 104 is notified that customer 106 is moving product 404 from first location 400 to a second location 406 (Step 320). In some embodiments, this notification may be received via a form on a web-site as part of interface 212. Customer 106 may enter information indicating the product's move into the form and submit the form to manufacturer business system 208, which may subsequently respond in the manner outlined below. Information entered to indicate the move may include product's 404 unique product identifier, second location 406, and the anticipated date of the product's arrival at second location 406. In an alternate embodiment, the product's movement may be automatically tracked by means of a tracking device, such as a Global Positioning Satellite (GPS) device, without interaction from customer 106.

Manufacturer business system 208 may subsequently notify service dealer 402 via mail, e-mail, or another notification method that product 404 will be leaving its service area (Step 322). Similarly, manufacturer business system 208 may use the same process outlined in step 318 to identify a service dealer 408 near the second location 406 that product 404 will be entering its service area on the anticipated arrival date. Service dealer 110 may then be able to log in to a web-site as part of interface 212 to view the service history report of product 404 and parts list for product 404. This data may allow service dealer 110 to prepare for the product's upcoming service needs by ensuring the required quantity of necessary parts are in stock. Manufacturer business system 208 may further notify service dealer 402 that once product 404 has arrived at second location 406, it will no longer have access to the service history report of product 404. Once product 404 has arrived at second location 406, customer 106 may further notify manufacturer business system 208 that the move is complete (Step 324), thus triggering a change of service dealer information associated with product 404 in customer information database 216 and/or service information database 220 from service dealer 402 to service dealer 408 (Step 326). This change may be manually entered by manufacturer 102 via I/O devices 210 and/or interface 212, or automatically processed by manufacturer business system 208.

The methods and systems detailed in the present disclosure allow for an efficient transfer of data between a customer, a plurality of servicing entities, and a manufacturer. The information may be manually entered, but in most cases can be transferred automatically as part of other existing processes, such as product orders or warranty processing. For example, when repairs on a product fall under the product's warranty, the warranty information communicated to manufacturer can be automatically added to the product's service history records, maintaining a consistent data entry style, and reducing the risk for potentially erroneous data, such as typos.

The data flow in the methods and systems of the present disclosure may be controlled such that data may be entered regularly and automatically, as outlined above, and each party involved in a product's maintenance may be as informed as necessary to offer efficient, quality service to the product. In particular, the service dealer responsible for a product at any given time may view the product's service history record via I/O devices 210 and/or interface 212 and prepare for maintenance accordingly, and the end-user customer of the product may perceive the dealer's preparedness in servicing its product as a sign of good service habits. Other service dealers who are not responsible for servicing the product may not be allowed to view the product's service history, and may not be burdened by unnecessary data.

Finally, systems and methods consistent with the disclosed embodiments may provide product service tracking processes that potentially improve the service of service dealers who can prepare their schedules, equipment, and inventory for foreseeable repairs and maintenance. This can decrease waiting time for customers when a product requires service. Customers may find that products that they incorporate into systems consistent with the present disclosure are easily and efficiently maintained, thus potentially increasing their satisfaction with the products. As a result, service histories may be managed and delivered to service dealers 110, and service dealer demographic information may be managed and delivered to customers 106, allowing a fluid transition in service from a service dealer in a first location to a service dealer in a second location.

It will be apparent to those skilled in the art that various modifications and variations can be made to the disclosed methods for managing and transferring product service records. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium, tangibly embodied, including a product service history database, the computer-readable medium comprising instructions for:
receiving service information associated with a product;
receiving service dealer demographic information;
receiving an indication of a transfer of the product from a first location to a second location;
determining a service dealer associated with the second location; and
providing the service information to the service dealer.

2. The computer-readable medium of claim 1, wherein the service information includes at least one of a parts list, service instructions, service history, warranty information, safety information, end-user's application, serial number, and location of the product.

3. The computer-readable medium of claim 1, wherein the dealer demographic information includes at least one of the dealer's name, the dealer's location, the dealer's contact information, products the dealer is equipped to service, and servicing equipment available to the dealer.

4. The computer-readable medium of claim 1, wherein the indication includes the second location and the expected arrival date of the product at the second location.

5. The computer-readable medium of claim 1, wherein providing includes enabling the service dealer from the second location to view the service information via a computer interface.

6. The computer-readable medium of claim 1, further including instructions for disabling a service dealer associated with the first location from viewing the service information.

7. The computer-readable medium of claim 1, further including instructions for receiving end-user demographic information, including at least one of the end-user's name, the end-user's location, the end-user's contact information, and products currently under the end-user's keeping.

8. The computer-readable medium of claim 1, further including instructions for receiving product application information from the product's end-user.

9. A method for providing a product service history database, comprising:
receiving service information associated with a product;
receiving service dealer demographic information;
receiving an indication of a transfer of the product from a first location to a second location;
determining a service dealer associated with the second location; and
providing the service information to the service dealer.

10. The method of claim 9, wherein the service information includes at least one of a parts list, service instructions, service history, warranty information, safety information, end-user's application, serial number, and location of the product.

11. The method of claim 9, wherein the dealer demographic information includes at least one of the dealer's name, the dealer's location, the dealer's contact information, products the dealer is equipped to service, and servicing equipment available to the dealer.

12. The method of claim 9, wherein the indication includes the second location and the expected arrival date of the product at the second location.

13. The method of claim 9, wherein providing includes enabling the service dealer from the second location to view the service information via a computer interface.

14. The method of claim 9, further including disabling a service dealer associated with the first location from viewing the service information.

15. The method of claim 9, further including receiving end-user demographic information, including at least one of the end-user's name, the end-user's location, the end-user's contact information, and products currently under the end-user's keeping.

16. The method of claim 9, further including receiving product application information from the product's end-user.

17. A computer system, comprising:
a platform;
at least one input device; and
a central processing unit in communication with the platform and the at least one input device, the central processing unit configured to:
receive service information associated with a product;
receive service dealer demographic information;
receive an indication of a transfer of the product from a first location to a second location;
determine a service dealer associated with the second location; and
provide the service information to the service dealer.

18. The computer system of claim 17, wherein:
the service information includes at least one of a parts list, service instructions, service history, warranty information, safety information, end-user's application, serial number, and location of the product; and
the dealer demographic information includes at least one of the dealer's name, the dealer's location, the dealer's contact information, products the dealer is equipped to service, and servicing equipment available to the dealer.

19. The computer system of claim 17, wherein:
the indication includes the second location and the expected arrival date of the product at the second location; and
providing includes enabling the service dealer from the second location to view the service information via a computer interface.

20. The computer system of claim 17, wherein the central processing unit is further configured to receive:
end-user demographic information, including at least one of the end-user's name, the end-user's location, the end-user's contact information, and products currently under the end-user's keeping; and
product application information from the product's end-user.
